(19) United States
(12) Patent Application Publication
(10) Pub. No.: US 2011/0086949 A1
(43) Pub. Date: Apr. 14, 2011

(54) STARCH-CONTAINING THERMOPLASTIC OR ELASTOMER COMPOSITIONS, AND METHOD FOR PREPARING SUCH COMPOSITIONS

(75) Inventors: Léon Mentink, Lille (FR); Jérôme Gimenez, Villeurbanne (FR); Didier Lagneaux, Bluffy (FR)

(73) Assignee: ROQUETTE FRERES, Lestrem (FR)

(21) Appl. No.: 12/997,842

(22) PCT Filed: Jun. 12, 2009
(86) PCT No.: PCT/FR2009/051112

§ 371 Date: Dec. 13, 2010

(30) Foreign Application Priority Data
Jun. 13, 2008 (FR) 0853952

(51) Int. Cl. C08L 3/02; C08L 3/04; C08L 3/06; C08L 3/10; B82Y 30/00

(52) U.S. Cl. 524/48; 524/47; 524/51; 524/53; 524/52; 977/742; 977/773; 977/700

(57) ABSTRACT

A thermoplastic and/or elastomer composition includes: at least 50 wt % and 99.95 wt % at most of a starchy composition (a) including at least one starch; at least 0.05 wt % and 50 wt % at most of a nanometric product (b) including particles having at least one dimension of 0.1 to 500 nanometers and selected from mixed products containing at least one lamellar clay and at least one cationic oligomer or cationic synthetic polymer, organic, mineral or mixed nanotubes, organic, mineral or mixed nanocrystals and nanocrystallites, organic, mineral or mixed nanobeads and nanospheres customized into clusters or agglomerated, and mixtures of these nanometric products, the percentage being expressed in dry weight and added to the sum in dry weight of (a) and (b); and at least one non-starchy polymer (c).

The present invention relates to novel thermoplastic and/or elastomeric compositions and to a process for the preparation of these compositions.

The term “thermoplastic and/or elastomeric composition” is understood to mean, in the present invention, a composition which reversibly softens under the action of heat and hardens on cooling (thermoplastic) and/or more or less rapidly resumes its original shape and its starting dimensions after application of a strain under stress (elastomeric). It exhibits at least one “glass transition” temperature (Tg) below which the amorphous fraction of the composition is in the brittle glassy state and above which the composition can be subjected to reversible plastic strains. The glass transition temperature or one at least of the glass transition temperatures of the starch-based thermoplastic composition of the present invention is preferably between −120° C. and 150° C. This composition can in particular be thermoplastic, that is to say can exhibit an ability to be shaped by the processes conventionally used in plastics technology, such as extrusion, injection molding, molding, rotational molding, blow molding and calendering. Its viscosity, measured at a temperature of 100° C. to 200° C., is generally between 10 and 10⁶ Pa·s. This composition can also be elastomeric, that is to say can exhibit a high capacity for extensibility and for elastic recovery, like natural or synthetic rubbers. The elastomeric behavior of the composition can be obtained or improved by more or less forceful crosslinking or vulcanization, after shaping in the plastic state.

Preferably, said composition is a “hot melt” composition, that is to say that it can be shaped without application of high shear forces, that is to say by simple flowing or by simple pressing of the melt. Its viscosity, measured at a temperature of 100° C. to 200° C., is generally between 10 and 10³ Pa·s.

In the current context of climatic disturbances due to the greenhouse effect and to global warming, of the upward trend in the costs of fossil starting materials, in particular of oil, from which plastics are derived, of the state of public opinion in search of sustainable development, of products which are more natural, cleaner, healthier and more energy efficient, and of the change in regulations and tax systems, it is necessary to have available novel compositions resulting from renewable resources which are suitable in particular for the field of plastics and which are simultaneously competitive, designed from the start to have only few or no negative impacts on the environment and technically as effective as the polymers prepared from starting materials of fossil origin.

Starch constitutes a starting material which exhibits the advantages of being renewable, biodegradable and available in large amounts at a price which is economically advantageous in comparison with oil and gas, used as starting materials for current plastics.

The biodegradable nature of starch has already been made use of in manufacture of plastics, this being done according to two main technical solutions.

The first starch-based compositions were developed approximately thirty years ago. The starches were then employed in the form of blends with synthetic polymers, such as polyethylene, as filler, in the granular native state. Before dispersion in the synthetic polymer constituting the matrix, or continuous phase, the native starch was then preferably dried up to a moisture level of less than 1% by weight, in order to decrease its hydrophilic nature. For the same purpose, it could also be coated with fatty substances (fatty acids, silicones, siliconates) or also be modified at the surface of the grains with siloxanes or isocyanates.

The materials thus obtained generally comprised approximately 10% by weight, at the very most 20% by weight, of granular starch as, beyond this value, the mechanical properties of the composite materials obtained became too imperfect and reduced in comparison with those of the synthetic polymers forming the matrix. Furthermore, it was apparent that such polyethylene-based compositions were only biofragmentable and not biodegradable as expected, so that the hoped-for rapid development of these compositions did not take place. In order to overcome the lack of biodegradability, the same principle was subsequently expanded upon with the replacement of the conventional polyethylene by oxidatively degradable polyethylenes or by biodegradable polyesters, such as polyhydroxybutyrate-co-hydroxyvalerate (PHBV) or poly(lactic acid) (PLA). Here again, the mechanical properties of such composites, obtained by blending with granular starch, proved to be inadequate. Reference may be made, if need be, to the excellent book “La Chimie Verte” [Green Chemistry], Paul Colonna, Editions TEC & DOC, January 2006, chapter 6, entitled “Matériaux à base d'amidons et de leurs dérivés” [Materials based on starches and on their derivatives] by Denis Lourdin and Paul Colonna, pages 161 to 166.

Subsequently, the starch was used in an essentially amorphous and thermoplastic state. This state is obtained by plasticizing the starch by incorporation of an appropriate plasticizer at a level of generally between 15 and 25% with respect to the granular starch, by contributing mechanical and thermal energy. U.S. Pat. No. 5,095,054 of Warner Lambert and EP 0 497 706 B1 of the Applicant Company describe in particular this destructured state, having reduced or absent crystallinity by virtue of the addition of plasticizer, and means for obtaining such thermoplastic starches.

However, the mechanical properties of the thermoplastic starches, although they can to a certain extent be adjusted by the choice of the starch, of the plasticizer and of the level of use of the latter, are overall fairly mediocre as the materials thus obtained are always very highly viscous, even at high temperature (120° C. to 170° C.), and very easily damaged, excessively brittle and very hard at low temperature, that is to say below the glass transition temperature or the highest glass transition temperature.

Thus, the elongation at break of such thermoplastic starches is very low, always less than approximately 10%, this being the case even with a very high level of plasticizer of the order of 30%. By way of comparison, the elongation at break of low density polyethylenes is generally between 100 and 1000%.

Furthermore, the maximum tensile strength of the thermoplastic starches decreases very strongly when the level of plasticizer increases. It has an acceptable value, of the order of 15 to 60 MPa, for a plasticizer content of 10 to 25% but decreases unacceptably beyond 30%.

For this reason, these thermoplastic starches have formed the subject of numerous research studies targeted at developing biodegradable and/or water-soluble formulations exhibiting better mechanical properties by physically blending these thermoplastic starches, either with, on the one hand, polymers of petroleum origin, such as poly(vinyl acetate) (PVA), poly(vinyl alcohol) (PVOH), ethylene/vinyl alcohol (EVOH) copolymers, biodegradable polyesters, such as polycaprolactones (PCLs), poly(butylene adipate terephthalate)s (PBATs), such as the products sold under the “Ecoflex” and “Ecovio” trade marks, poly(butylene succinate)s (PBSs) and poly(butylene succinate adipate)s (PBSAs), such as the products sold under the “Bionolle” trade mark, or with, on the other hand, polyesters of renewable origin, such as poly(lactic acid) (PLA), for example the products sold under the “Ingeo” trade mark, or microbial polyhydroxyalkanoates (PHA, PHB and PHBV), such as the products sold under the “Nodax” and “Mirel” trade marks, or with, on the other hand again, natural polymers extracted from plants or from animal tissues. Reference may again be made to the book “La Chimie Verte”, Paul Colonna, Editions TEC & DOC, pages 161 to 166, but also, for example, to patents EP 0 579 546 B1, EP 0 735 104 B1 and FR 2 697 259 of the Applicant Company, which describe compositions comprising thermoplastic starches.

Under a microscope, these resins appear as very heterogeneous and exhibit islets of plasticized starch in a continuous phase of synthetic polymers. This is due to the fact that the thermoplastic starches are very hydrophilic and are consequently not very compatible with the synthetic polymers. The result of this is that the mechanical properties of such blends, even with addition of compatibilizing agents, such as copolymers comprising alternating hydrophobic units and hydrophilic units, such as ethylene/acrylic acid (EAA) copolymers, or also cyclodextrins or organosilanes, remain fairly limited.

By way of example, the commercial product Mater-Bi of Y grade exhibits, according to the information supplied by its manufacturer, an elongation at break of 27% and a maximum tensile strength of 26 MPa. Consequently, these composite materials currently have restricted uses, that is to say uses limited essentially just to the sectors of exterior packaging, garbage bags, checkout bags and certain rigid solid items which are biodegradable.

The destructuring of the semicrystalline native granular state of the starch in order to produce thermoplastic amorphous starches can be carried out in a relatively anhydrous medium by extrusion processes. To obtain a melt phase starting from the starch granules requires not only a significant contribution of mechanical energy and of thermal energy but also the presence of a plasticizer at the risk otherwise of carbonizing the starch.

The term “plasticizer of the starch” is understood to mean any organic molecule of low molecular weight, that is to say preferably having a molecular weight of less than 5000, which, when it is incorporated in the starch by a thermomechanical treatment at a temperature of between 20 and 200° C., results in a reduction in the glass transition temperature and/or in a reduction in the crystallinity of a granular starch down to a value of less than 15%, indeed even to an essentially amorphous state.

Water is the most natural plasticizer for starch and it is consequently commonly employed but other molecules are also highly effective, in particular sugars, such as glucose, maltose, fructose or sucrose; polyols, such as ethylene glycol, propylene glycol, polyethylene glycols (PEGs), glycerol, sorbitol, xylitol, maltitol or hydrogenated glucose syrups; urea; salts of organic acids, such as sodium lactate, and the mixtures of these products.

The amount of energy to be applied in order to plasticize the starch can advantageously be reduced by increasing the amount of plasticizer. In practice, the use of a plasticizer at a high level with respect to the starch however brings about various technical problems, among which may be mentioned the following:
a release of the plasticizer from the plasticized matrix from the end of the manufacture or during the storage time, so that it is impossible to retain an amount of plasticizer as high as desired and consequently to obtain a sufficiently flexible and film-forming material,
high instability in the mechanical properties of the plasticized starch, which hardens or softens according to atmospheric moisture respectively when its water content decreases or increases,
the whitening or opacifying of the surface of the composition by crystallization of the plasticizer used at a high dose, such as, for example, in the case of xylitol,
a tacky or oily nature of the surface, as in the case of glycerol, for example,
a very poor water resistance, which worsens as the plasticizer content increases. A loss of physical integrity is observed in water, so that the plasticized starch cannot, at the end of manufacture, be cooled by immersion in a water bath, as for conventional polymers. For this reason, its uses are very limited.

In order to extend its operational possibilities, it is necessary to blend it with large amounts, generally greater than or equal to 60%, of polyesters or other expensive polymers.
a possible premature hydrolysis of the polyesters (PLA, PBAT, PCL, PET) optionally used in combination with the thermoplastic starch.

The present invention provides an effective solution to the problems set out above by providing novel starch-based compositions exhibiting improved properties in comparison with those of the prior art.

This is because the Applicant Company has found, after much work, that, surprisingly and unexpectedly, the joint use (a) of specific nanometric products, that is to say products composed of particles having at least one dimension of between 0.1 and 500 nanometers, in defined proportions, and (b) of nonamylaceous polymers advantageously makes it possible to obtain the maximum, indeed even all, of the effects below:
to adjust the melting viscosity and the melt viscosity of the starch-based composition according to the invention and more generally its rheological properties, so that this composition exhibits a true thermoplastic behavior, indeed even hot melt behavior, in contrast to an identical starch composition devoid of nanometric product,
to limit the hardening on cooling related to a retrogradation of the starch within the composition and
to consequently retain a thermoplastic nature (reversible thermal softening),
to reduce the browning or the decomposition of the starch-based composition during the heating cycles necessary for its processing or for its shaping,
to make it possible, if need be, to introduce into the compositions, in a way stable over time, a high to very high amount of plasticizer with a limited, indeed even zero, release and, for this reason, to obtain a composition with a high mechanical flexibility which can be drawn under stress and which readily forms films,
to improve the compatibility between starch and nonamylaceous polymer,
to give rise to blends exhibiting very good mechanical characteristics (tensile strength and/or elongation at break) and other characteristics (good resistance to water and to moisture, high level of insoluble materials),
to lessen, by neutralization, the risks of premature hydrolysis of the polyesters (PLA, PBAT, PCL, PET) optionally used in combination with the thermoplastic starch,
to considerably improve the processing properties of the composition, so that the technologies in place for ordinary plastic polymers can easily be used, and
to make it possible to obtain a starch-based composition exhibiting improved functional properties in comparison with a starch composition of the prior art which is identical but devoid of nanometric product, in particular in terms of resistance to water, to moisture and/or to light, of barrier effects to the migration of liquid or gas molecules, of organoleptic characteristics (smoother appearance, more pleasant feel, optimized transparency, reduced coloring, absence of smell) and of applicational properties (conduction of heat, electrical conduction, fitness for painting, printability).

A subject matter of the present invention is consequently a thermoplastic and/or elastomeric composition comprising:
at least 50% by weight and at most 99.95% by weight of an amylaceous composition (a) comprising at least one starch,
at least 0.05% by weight and at most 50% by weight of a nanometric product (b) composed of particles having at least one dimension of between 0.1 and 500 nanometers and chosen from:
products formed of mixtures based on at least one lamellar clay and on at least one cationic oligomer,
organic, inorganic or mixed nanotubes,
organic, inorganic or mixed nanocrystals and nanocrystallites,
organic, inorganic or mixed nanobeads and nanospheres which are separate, in bunches or agglomerated, and
any mixture of at least two of these nanometric products,
   these percentages being expressed by dry weight and with respect to the sum, by dry weight, of (a) and (b), and
at least one nonamylaceous polymer (c).

The term “cationic oligomer” is understood to mean, within the meaning of the present invention, a cationic polymer of relatively small size, of organic nature and of natural or non-natural origin, composed of a number of monomer units such that the molecular weight of said oligomer does not exceed 200 000 daltons, it being possible for each of said monomer units to be or not to be cationic, the oligomer being positively charged overall.

The nanometric product (b) selected improves the behavior toward processing and toward shaping of the composition according to the invention but also its durability or else its mechanical, thermal, conductive, adhesive and/or organoleptic properties. It can be of any chemical nature and can optionally be deposited on or fixed to a support.

Advantageously, the nanometric product (b) is composed of particles having at least one dimension of between 0.5 and 200 nanometers, preferably of between 0.5 and 100 nanometers and more preferably still of between 1 and 50 nanometers. This dimension is in particular between 5 and 50 nanometers.

The thermoplastic and/or elastomeric composition in accordance with the invention advantageously comprises
at least 55% by weight, preferably at least 60% by weight, of an amylaceous composition (a) comprising at least one starch and optionally at least one plasticizer of the latter, and
at most 45% by weight, preferably at most 40% by weight, of a nanometric product (b) as defined above, these percentages being expressed as indicated above.

According to an advantageous alternative form, the thermoplastic and/or elastomeric composition of the invention comprises:
at least 80% by weight, preferably at least 90% by weight, of an amylaceous composition (a) comprising at least one starch and optionally at least one plasticizer of the latter, and
at most 20% by weight, preferably at most 10% by weight, of a nanometric product (b) as defined above, these percentages being expressed as indicated above.

By way of example, the composition according to the invention can comprise only from 0.1 to 4% by weight of a nanometric product (b) advantageously composed of particles having at least one dimension of between 5 and 50 nanometers.

Conversely, according to another alternative form and in particular when the composition of the invention constitutes a masterbatch intended to be subsequently diluted with another polymeric composition, preferably also comprising at least one nonamylaceous polymer, said composition can comprise a relatively high proportion, that is to say from 5 to 40% by weight, preferably between 6 and 35% by weight, of a nanometric product (b). This proportion can in particular be between 8 and 30% by weight.

During the preparation of such a masterbatch, the nanometric product is advantageously composed of particles having at least one dimension of between 5 and 50 nanometers.

According to another alternative form, the composition according to the invention comprises:
from 10 to 98% by weight, preferably from 25 to 95% by weight, of an amylaceous composition (a) comprising at least one starch and preferably at least one plasticizer of the latter,
from 1 to 50% by weight of a nanometric product (b), and
from 1 to 70% by weight, preferably from 5 to 60% by weight, of at least one nonamylaceous polymer (c), these percentages being expressed by dry weight and with respect to the total dry weight of the thermoplastic or elastomeric composition according to the invention.

By way of example, the composition according to the invention can comprise a relatively low proportion, that is to say from 1 to 20% by weight (dry/dry), in particular from 2 to 10% by weight (dry/dry), of a nanometric product (b).

Conversely, according to another alternative form and in particular when the composition in accordance with the invention constitutes a masterbatch, said composition can comprise a relatively high proportion, that is to say from 5 to 45% by weight (dry/dry), in particular from 5 to 40% by weight (dry/dry), of a nanometric product (b).

The starch present in the amylaceous composition (a) preferably exhibits a degree of crystallinity of less than 15%, preferably of less than 5% and more preferably of less than 1%.

This degree of crystallinity can in particular be measured by X-ray diffraction, as described in U.S. Pat. No. 5,362,777 (column 9, lines 8 to 24).

The amylaceous composition (a) is advantageously substantially devoid of starch grains exhibiting, by polarized light microscopy, a Maltese cross, a feature indicative of the presence of crystalline granular starch.

The operation for bringing products based on nanoparticles into contact with starch-based compositions has already been described.

However, in a certain number of cases, this contacting operation:

a) is only temporary, the aim being to use the starch-based composition as means for purifying said nanoparticles in a liquid medium (solution), such as, for example, described in the paper by A. Star et al., Angew. Chem. Int. Ed., 2002, 41, No. 14, pp. 2508-2512,
b) takes place in intermediate or final mixtures which are not in the least thermoplastic or elastomeric compositions, such as described in applications EP 1 506 765, FR 2 795 081 and WO 2007/000193 or in the paper by J. Sundaram et al., Acta Biomateriala, 4 (2008), pp. 932-942.

Furthermore, the use of products based on nanoparticles to formulate thermoplastic or elastomeric starch-based compositions has certainly already been described but this has been done either, on the one hand, in the absence of any nonamylaceous polymer or, on the other hand, with types of products different from those of the present invention or else under conditions or in proportions different from those claimed.

Thus,

a) applications WO 01/68762, WO 2007/027114 and EP 1 626 067 and the paper by X. Ma et al., Composites Science and Technology, 68 (2008), pp. 268-273, describe and exemplify compositions combining starch and nanofiller, which compositions do not, however, comprise nonamylaceous polymer, and
b) applications WO 03/035044, WO 2007/027114 and WO 2008/090195 describe, in very general terms and without giving examples thereof, the possibility of using, in undefined proportions or proportions included within very broad ranges, numerous nanometric or non-nanometric fillers, of generally inorganic nature, in thermoplastic compositions comprising an amylaceous composition.

Various authors have carried out studies in which clays of phyllosilicate or sheet silicate type, in particular of montmorillonite type, are added to matrices formed of polymers of natural origin, such as starch, for the purpose of improving the characteristics thereof.

Mention may be made, as such, of patent application EP 1 229 075, which does not envisage any specific exfoliating agent, in particular of cationic nature, for improving the conditions for exfoliation of the phyllosilicate. In this document, it is only envisaged to “activate” the phyllosilicate with water, this being performed during the extrusion operation, which takes place at a relatively low temperature (at most equal to 150° C., in practice between 75 and 105° C.).

Mention may also be made of the above-mentioned international application WO 01/68762, filed by Nederlandse Org Toegeplast Natuurwetensch (TNO), claiming a biodegradable thermoplastic comprising a natural polymer, a plasticizer and a clay exhibiting a layered structure and an ion-exchange capacity of between 30 and 250 milliequivalents per 100 g. The natural polymer can be a carbohydrate, such as starch. This patent application mentions the advantage of pretreating the clay in a highly diluted aqueous medium at 60° C. for 24 h, in the presence of a “modifying agent” of polymeric nature which generates onium (ammonium, phosphonium, sulfonium) ions, such as, for example, cationic starch, in order to render this clay compatible with the natural polymer.

Tests carried out by the Applicant Company have shown that such compositions, when they are prepared from plasticized starch as described in particular in example 3 of this document, do not exhibit a satisfactory resistance to water or satisfactory mechanical or organoleptic properties. After analysis by the Applicant Company, this fault appears to be related to poor or very imperfect exfoliation of the clays under the conditions recommended in this patent application. Without wishing to be committed to any one theory, the Applicant Company believes that this poor exfoliation is due mainly to a molecular weight of the cationic starch employed in this patent application which is far too high; a cationic starch conventionally exhibiting a molecular weight of 1 to several million daltons as used in this application then proving to be rather a compatibilizing agent than an exfoliating agent for the clay.

Finally, this document does not teach the advantage of using a combination of inorganic nanolayers of clay type or other lamellar inorganic materials, on the one hand, and of cationic oligomers, such as, in particular, cationic oligosaccharides and/or proteins, on the other hand.

The Applicant Company has found that such cationic oligomers are highly efficient exfoliating agents.

Other documents, such as the paper “Biopolymer nanocomposites containing native wheat starch and nanoclays” by Chiou B. S. et al., ACS National Meeting Book of Abstract 228/1 IEC-41, 2004, relate to studies with sodic clays or clays treated with surfactants in the manufacture of thermoplastic composites based on native and nonplasticized wheat starch. A certain beneficial effect on the mechanical properties and on the water absorption is recorded only in the case of use of native sodic clays, that is to say clays not treated with any organic or inorganic or polymeric or nonpolymeric substance.

To the best knowledge of the Applicant Company, apart from clays or other lamellar inorganic materials, no nanofiller has a priori been used to improve the processing properties, the functional properties or the stability on storage of thermoplastic or elastomeric compositions based on starch and on nonamylaceous polymer.

The starch used in the preparation of the amylaceous composition (a) is preferably chosen from granular starches, water-soluble starches and organomodified starches.

The term “granular starch” is understood to mean, within the meaning of the invention, a native starch or a starch which has been modified physically, chemically or enzymatically and which has retained a semicrystalline structure similar to that demonstrated in the starch grains present naturally in the storage tissues and organs of higher plants, in particular in seeds of cereals, seeds of leguminous plants, tubers of potato or cassava, roots, bulbs, stems and fruits. This semicrystalline state is essentially due to macromolecules of amylopectin, one of the two main constituents of starch. In the native state, starch grains exhibit a degree of crystallinity which varies from 15 to 45% and which depends essentially on the botanical origin of the starch and on the optional treatment which it has been subjected to. Granular starch, placed under polarized light, exhibits in microscopy a characteristic cross, referred to as “Maltese cross”, typical of the crystalline granular state. For a more detailed description of granular starch, reference may be made to Chapter II, entitled “Structure et morphologie du grain d'amidon” [Structure and morphology of the starch grain], by S. Perez in the work “Initiation à la chimie et à la physico-chimie macromoléculaires” [Introduction to macromolecular chemistry and physical chemistry], first edition, 2000, Volume 13, pages 41 to 86, Groupe Français d'Etudes et d'Applications des Polymères [French Group for Studies and Applications of Polymers].

According to a first alternative form, the starch selected for the preparation of the amylaceous composition (a) is a granular starch. The crystallinity of said granular starch can be rendered lower than 15% by a thermomechanical treatment and/or intimate blending with an appropriate plasticizer. Said granular starch can be of any botanical origin. It can be native starch of cereals, such as wheat, corn, barley, triticale, sorghum or rice, of tubers, such as potato or cassava, or of leguminous plants, such as peas and soybean, starches rich in amylose or conversely rich in amylopectin (waxy) resulting from these plants, and any mixture of the abovementioned starches. The granular starch can also be a granular starch modified by any physical, chemical and/or enzymatic means. It can be any fluidized or oxidized granular starch or a white dextrin. It can also be a granular starch which has been modified physicochemically but which has been able to retain the structure of the starting native starch, such as esterified and/or etherified starches, in particular starches modified by grafting, acetylation, hydroxypropylation, anionization, cationization, crosslinking, phosphation, succinylation and/or silylation. Finally, it can be a starch modified by a combination of the treatments set out above or any mixture of such granular starches.

In a preferred embodiment, this granular starch is chosen from fluidized starches, oxidized starches, starches which have been subjected to a chemical modification, white dextrins and any mixture of these products.

The granular starch is preferably a wheat or pea granular starch or a granular derivative of wheat or pea starch.

The granular starch used generally exhibits a level of soluble materials at 20° C. in demineralized water of less than 5% by weight. It can be virtually insoluble in cold water.

According to a second alternative form, the starch selected for the preparation of the amylaceous composition (a) is a water-soluble starch which can also originate from any botanical source, including a water-soluble starch rich in amylose or conversely rich in amylopectin (waxy). This soluble starch can be introduced as partial or complete replacement for the granular starch.

The term “water-soluble starch” is understood to mean, within the meaning of the invention, any starch-derived polysaccharide material which exhibits, at 20° C. and under mechanical stirring for 24 hours, a fraction soluble in demineralized water at least equal to 5% by weight. This soluble fraction is preferably greater than 20% by weight and in particular greater than 50% by weight. Of course, the soluble starch can be completely soluble in the demineralized water (soluble fraction=100%).

The water-soluble starch is used in the solid form, preferably the essentially anhydrous solid form, that is to say not dissolved or not dispersed in an aqueous or organic solvent. It is thus important not to confuse, throughout the description which follows, the term “water-soluble” with the term “dissolved”.

Such water-soluble starches can be obtained by pregelatinization on a drum, by pregelatinization on an extruder, by atomization of an amylaceous suspension or solution, by precipitation with a nonsolvent, by hydrothermal cooking, by chemical functionalization or by another technique. It is in particular a pregelatinized, extruded or atomized starch, a highly converted dextrin (also known as yellow dextrin), a maltodextrin, a functionalized starch or a mixture of these products.

The pregelatinized starches can be obtained by hydrothermal gelatinization treatment of native starches or modified starches, in particular by steam cooking, jet-cooker cooking, cooking on a drum, cooking in kneader/extruder systems and then drying, for example in an oven, with hot air on a fluidized bed, on a rotating drum, by atomization, by extrusion or by lyophilization. Such starches generally exhibit a solubility in demineralized water at 20° C. of greater than 5% and more generally of between 10 and 100% and a degree of starch crystallinity of less than 15%, generally of less than 5% and most often of less than 1%, indeed even zero. Mention may be made, by way of example, of the products manufactured and sold by the Applicant Company under the Pregeflo® trade name.

The highly converted dextrins can be prepared from native or modified starches by dextrinization in a relatively anhydrous acidic medium. They can in particular be soluble white dextrins or be yellow dextrins. Mention may be made, by way of example, of the products Stabilys® A 053 or Tackidex® C 072 manufactured and sold by the Applicant Company. Such dextrins exhibit, in demineralized water at 20° C., a solubility generally of between 10 and 95% and a starch crystallinity of less than 15% and generally of less than 5%.

The maltodextrins can be obtained by acid, oxidizing or enzymatic hydrolysis of starches in an aqueous medium. They can in particular exhibit a dextrose equivalent (DE) of between 0.5 and 40, preferably between 0.5 and better still between 0.5 and 12. Such maltodextrins are, for example, manufactured and sold by the Applicant Company under the Glucidex® trade name and exhibit a solubility in demineralized water at 20° C. generally of greater than 90%, indeed even of close to 100%, and a starch crystallinity generally of less than 5% and ordinarily of virtually zero.

The functionalized starches can be obtained from a native or modified starch. The high functionalization can, for example, be achieved by esterification or etherification to a sufficiently high level to confer thereon a solubility in water. Such functionalized starches exhibit a soluble fraction as defined above of greater than 5%, preferably of greater than 10%, better still of greater than 50%.

The functionalization can be obtained in particular by acetylation in an aqueous phase with acetic anhydride or mixed anhydrides, hydroxypropylation in a tacky phase, cationization in a dry phase or tacky phase, or anionization in a dry phase or tacky phase by phosphation or succinylation. These water-soluble highly functionalized starches can exhibit a degree of substitution of between 0.01 and 3 and better still of between 0.05 and 1. Preferably, the reactants for modifying or functionalizing the starch are of renewable origin.

According to another advantageous alternative form, the water-soluble starch is a wheat or pea water-soluble starch or a water-soluble derivative of a wheat or pea starch.

It advantageously exhibits a low water content generally of less than 10% by weight, preferably of less than 5% by weight, in particular of less than 2% by weight and ideally of less than 0.5% by weight, indeed even of less than 0.2% by weight.

According to a third alternative form, the starch selected for the preparation of the amylaceous composition (a) is an organomodified starch, preferably an organosoluble starch, which can also originate from any botanical source, including an organomodified starch, preferably an organosoluble starch, rich in amylose or conversely rich in amylopectin (waxy). This organosoluble starch can be introduced as partial or complete replacement for the granular starch or for the water-soluble starch.

The term “organomodified starch” is understood to mean, within the meaning of the invention, any starch-derived polysaccharide material other than a granular starch or a water-soluble starch according to the definitions given above. Preferably, this organomodified starch is virtually amorphous, that is to say exhibits a degree of starch crystallinity of less than 5%, generally of less than 1%, and in particular a zero degree of starch crystallinity. It is also preferably “organosoluble”, that is to say exhibits, at 20° C., a fraction at least equal to 5% by weight soluble in a solvent chosen from ethanol, ethyl acetate, propyl acetate, butyl acetate, diethyl carbonate, propylene carbonate, dimethyl glutarate, triethyl citrate, dibasic esters, dimethyl sulfoxide (DMSO), dimethyl isosorbide, glycerol triacetate, isosorbide diacetate, isosorbide dioleate and methyl esters of vegetable oils. This soluble fraction is preferably greater than 20% by weight and in particular greater than 50% by weight. Of course, the organosoluble starch can be completely soluble in one or more of the solvents indicated above (soluble fraction=100%).

The organomodified starch can be used according to the invention in the solid form, preferably in the essential anhydrous form. Preferably, its water content is less than 10% by weight, preferably less than 5% by weight, in particular less than 2% by weight and ideally less than 0.5% by weight, indeed even less than 0.2% by weight.

The organomodified starch which can be used in the composition according to the invention can be prepared by a high functionalization of the native or modified starches, such as those presented above. This high functionalization can, for example, be carried out by esterification or etherification to a sufficiently high level to render it essentially amorphous and to confer on it an insolubility in water and preferably a solubility in one of the above organic solvents. Such functionalized starches exhibit a soluble fraction as defined above of greater than 5%, preferably of greater than 10%, better still of greater than 50%.

The high functionalization can be obtained in particular by acetylation in a solvent phase with acetic anhydride, grafting, for example in a solvent phase or by reactive extrusion, of acid anhydrides, of mixed anhydrides, of fatty acid chlorides, of oligomers of caprolactones or of lactides, hydroxypropylation and crosslinking in a tacky phase, cationization and crosslinking in a dry phase or in a tacky phase, anionization by phosphation or succinylation and crosslinking in a dry phase or in a tacky phase, silylation, telomerization with butadiene. These organomodified, preferably organosoluble, highly functionalized starches can in particular be acetates of starches, of dextrins or of maltodextrins or fatty esters of these amylaceous materials (starches, dextrins, maltodextrins) with fatty chains of 4 to 22 carbons, these combined products preferably exhibiting a degree of substitution (DS) of between 0.5 and 3.0, preferably of between 0.8 and 2.8 and in particular of between 1.0 and 2.7.

They can, for example, be hexanoates, octanoates, decanoates, laurates, palmitates, oleates and stearates of starches, of dextrins or of maltodextrins, in particular exhibiting a DS of between 0.8 and 2.8.

According to another advantageous alternative form, the organomodified starch is a wheat or pea organomodified starch or an organomodified derivative of a wheat or pea starch.

The plasticizer of the starch is preferably chosen from diols, triols and polyols, such as glycerol, polyglycerol, isosorbide, sorbitans, sorbitol, mannitol and hydrogenated glucose syrups, salts of organic acids, such as sodium lactate, urea and the mixtures of these products. The plasticizer advantageously exhibits a molar mass of less than 5000, preferably of less than 1000 and in particular of less than 400. The plasticizing agent preferably has a molar mass of greater than 18 and at most equal to 380, in other words it preferably does not encompass water.

The plasticizer of the starch, very particularly when the latter is organomodified, is preferably chosen from the methyl, ethyl or fatty esters of organic acids, such as lactic acid, citric acid, succinic acid, adipic acid and glutaric acid, and the acetic esters or fatty esters of monoalcohols, diols, triols or polyols, such as ethanol, diethylene glycol, glycerol and sorbitol. Mention may be made, by way of example, of glycerol diacetate (diacetin), glycerol triacetate (triacetin), isosorbide diacetate, isosorbide dioctanoate, isosorbide dioleate, isosorbide dilaurate, esters of dicarboxylic acids or dibasic esters (DBE), and the mixtures of these products.

The plasticizer, preferably other than water, is generally present in the amylaceous composition (a) in a proportion of 1 to 150 parts by dry weight, preferably in a proportion of 10 to 120 parts by dry weight and in particular in a proportion of 25 to 120 parts by dry weight, per 100 parts by dry weight of starch.

The Applicant Company has found that the present invention makes it possible to introduce, in a way stable over time, a high amount of plasticizer with a limited, indeed even zero, release and to thus obtain a plasticized amylaceous composition of high mechanical flexibility which can be drawn under stress and which readily forms films, these effects advantageously having repercussions on the properties of the final composition additionally comprising a nonamylaceous polymer.

Thus, according to an advantageous alternative form, the plasticizer, preferably other than water, is present in the amylaceous composition (a) in a proportion of 25 to 110 parts by dry weight, preferably in a proportion of 30 to 100 parts by dry weight and in particular in a proportion of 30 to 90 parts by dry weight, per 100 parts by dry weight of starch.

An additional subject matter of the present invention is a thermoplastic or elastomeric composition comprising very specific proportions of starch, of starch plasticizer, of nanometric product and of nonamylaceous polymer, said composition being characterized in that it comprises:
from 25 to 85% by weight of at least one starch,
from 8 to 40% by weight of at least one starch plasticizer, preferably other than water,
from 2 to 40% by weight of a nanometric product (b), and
from 5 to 60% by weight of at least one nonamylaceous polymer (c),
   these percentages being expressed by dry weight and with respect to the total dry weight of the thermoplastic or elastomeric composition according to the invention.

All the preferred ranges and alternative forms described above relating to the natures and proportions of the various ingredients also apply to these compositions.

The following advantageous alternative forms can in particular be listed:
the starch exhibits a degree of crystallinity of less than 5%, preferably of less than 1%,
the nanometric product (b) is composed of particles having at least one dimension of between 5 and 50 nanometers,
the nonamylaceous polymer (c) is a nonbiodegradable polymer preferably chosen from polyethylenes (PEs) and polypropylenes (PPs), which are preferably functionalized, thermoplastic polyurethanes (TPUs), polyamides, styrene-ethylene/butylene-styrene triblock block copolymers (SEBSs) and amorphous polyethylene terephthalate)s (PETGs), and/or
the nonamylaceous polymer (c) is a polymer comprising at least 50%, preferably at least 70%, in particular more than 80%, of carbon of renewable origin within the meaning of standard ASTM D 6852 and/or standard ASTM D 6866, with respect to the combined carbon present in said polymer.

The thermoplastic and/or elastomeric composition of the present invention preferably comprises at least one coupling agent chosen from compounds carrying at least two identical or different and free or masked functional groups chosen from isocyanate, carbamoylcaprolactam, aldehyde, epoxide, halo, protonic acid, acid anhydride, acyl halide, oxychloride, trimetaphosphate or alkoxysilane functional groups and combinations of these.

The thermoplastic and/or elastomeric composition comprises at least 50%, preferably at least 70%, in particular more than 80%, of carbon or renewable origin within the meaning of standard ASTM D 6852 and/or standard ASTM D 6866, with respect to the combined carbon present in said composition.

The thermoplastic and/or elastomeric composition is nonbiodegradable or noncompostable within the meaning of standards EN 13432, ASTM D 6400 and ASTM D 6868.

The thermoplastic or elastomeric composition simultaneously exhibits a level of insoluble materials at least equal to 98%, an elongation at break at least equal to 95% and a maximum tensile strength of greater than 8 MPa.

The nanometric product (b) as defined above can be a product of mixing, for example a mixture prepared or not prepared at the time of use, or any other combination combining at least one lamellar clay and at least one cationic oligomer. It can be a natural or synthetic clay.

The term “lamellar clay” is understood to include, within the meaning of the present invention, any inorganic structure made of nanolayers which can be separated (exfoliated), in particular by neutralization of the charges between these layers, in the form of lamellae with a nanometric thickness generally of between 0.1 and 50 nanometers, in particular between 0.5 and 10 nanometers, it being possible for the width and the length of these lamellae to reach several microns. These clays made of nanolayers, also called smectitic clays or also calcium and/or sodium silicates/phyllosilicates, are known in particular under the names of montmorillonite, bentonite, saponite, hydrotalcite, hectorite, fluorohectorite, attapulgite, beidellite, nontronite, vermiculite, halloysite, stevensite, manasseite, pyroauritei, sjogrenite, stichtite, barbertonite, tacovite, desaultelsite, motucoreaite, honessite, mountkeithite, wermlandite and glimmer. Their BET specific surfaces ordinarily exceed 50 m²/g and can reach 300 m²/g. Such lamellar clays are already commonly available commercially, for example from Rockwood under the Nanosil and Cloisite trade names. Mention may also be made of hydrotalcites, such as the Pural products from Sasol.

The cationic oligomer is preferably of biological origin. It can in particular be a cationic oligosaccharide or protein. Small angle X-ray diffraction has shown that these cationic oligomers are unexpectedly excellent exfoliating agents for lamellar clays and make it possible to directly obtain, during a thermomechanical treatment, virtually complete exfoliation of the lamellar clay and to thus considerably improve the properties of the thermoplastic and/or elastomeric composition obtained.

When the cationic oligomer is a protein, the latter is preferably soluble in water and is preferably extracted from a plant or from animal tissues. It can in particular relate to gelatins, caseins, wheat proteins (gluten), maize proteins (zein), soybean proteins, pea proteins, lupin proteins, rapeseed oil cake or proteins, sunflower oil cake or proteins, or potato proteins. Preferably, this protein is fluidized/hydrolyzed by mechanical, chemical or enzymatic treatment so as to reduce its molecular weight with respect to the native state as far as becoming an oligopeptide. Mention may be made, as proteins which can be used, of hydrolyzed wheat gluten, soluble pea proteins and potato proteins sold by the Applicant Company in particular under the Nutralys®, Lysamine® and Tubermine® trade names.

The cationic oligosaccharides which can be used as exfoliating agents are also preferably water-soluble and can originate from any source. Preferably, they result from tissues of plants, of algae, of animals, of insects or of microorganisms. They can in particular be oligosaccharides rendered cationic by a combined cationization and acid, enzymatic or mechanical hydrolysis treatment of cellulose, of starch, of guar gum, of mannan, of galactomannan, of alginate or of xanthan. They can also be oligosaccharides obtained from naturally cationic polymers, such as, for example, chitins or chitosans.

These cationic oligosaccharides preferably exhibit a molecular weight of between 100 and 200 000 daltons, more preferably of between 180 and 50 000 daltons and better still of between 180 and 20 000 daltons. Mention may be made, for example, as product which can advantageously be used, of the liquid mixture of cationic oligosaccharides sold by the Applicant Company under the name Vector® SC 20157.

Preferably, the nanometric product of mixing comprises, relative to the total weight of these two constituents, from 5 to 85%, preferably from 15 to 75%, of cationic oligosaccharides and/or proteins. It can be provided in the liquid, pulverulent or granulated form.

The cationic oligomer can in addition be a polyolefin, in particular polypropylene or polyethylene, grafted with or modified by groups carrying positive charges, for example quaternary ammonium and amine groups, in particular quaternary ammonium groups.

An additional subject matter of the present invention is the use of a cationic oligomer as defined above as exfoliating agent for a lamellar clay for the purpose of the preparation of a thermoplastic and/or elastomeric composition according to the invention.

The nanometric product (b) which can be used in accordance with the invention can also be composed of organic, inorganic or mixed nanotubes, that is to say composed of tubular structures with a diameter of the order of a few tenths of a nanometer to several tens of nanometers. Some of these products are already commercially available, such as carbon nanotubes, for example from Arkema under the Graphistrength and Nanostrength trade marks and Nanocyl under the Nanocyl, Plasticyl, Epocyl, Aquacyl and Thermocyl trade names.

Such nanotubes can also be cellulose nanofibrils, with a diameter of approximately 30 nanometers for a length of a few microns, which are composed of natural fibers of wood cellulose and can be obtained by separation and purification starting from the latter. They can also be clays having a tubular or fibrillar structure, such as sepiolites.

The nanometric product (b) which can be used according to the invention can also be a composition based on nanocrystals or on nanocrystallites. These structures can be organic, inorganic or mixed. They can be obtained by crystallization, optionally in situ, of materials in a very diluted solvent medium, it being possible for said solvent to be a constituent of the composition in accordance with the invention. Mention may be made of nanometals, such as iron or silver nanoparticles of use as reducing or antimicrobial agents and oxide nanocrystals known as agents for improving the resistance to scratching. Mention may also be made of synthetic nanometric talcs which can be obtained, for example, by crystallization from an aqueous solution. Mention may also be made, as such, of amylose/lipid complexes with structures of Vh(stearic), Vbutanol, Vglycerol, Visopropanol or Vnaphthol type, with a width or length of 1 to 10 microns, for a thickness of approximately ten nanometers. It can also relate to inclusion complexes with cyclodextrins. Finally, it can relate to nucleating agents for nonamylaceous polymers, in particular polyolefins, or to agents capable of crystallizing in the form of nanometric particles, such as sorbitol derivatives, for example dibenzylidene sorbitol (DBS), and the alkylated derivatives of the latter.

The nanometric product (b) which can be used can be provided as individual particles of nanobead or nanosphere type, that is to say in the form of pseudospheres with a radius of between 1 and 500 nanometers, in a separate form, as bunches or as agglomerates. It can in particular relate to organic, inorganic or mixed structures.

Mention may in particular be made of the carbon blacks commonly used as fillers for elastomers and rubbers. These carbon blacks comprise primary particles which a size which can be between approximately 8 nanometers (furnace blacks) and approximately 300 nanometers (thermal blacks) and generally exhibit oil absorption capacities of between 40 and 180 cc per 100 grams for STSA specific surfaces of between 5 and 160 m² per gram. Such carbon blacks are sold in particular by Cabot, Evonik, Sid Richardson, Columbian and Continental Carbon.

Mention may also be made of hydrophilic or hydrophobic and precipitated or fumed (pyrogenic) silicas, such as those used as flow agents for powders or fillers in “green” tires. Such silicas exhibit particle sizes generally of between 5 and 25 nanometers and are sold in particular in the form of powders or of dispersions in water, in ethylene glycol or in resins of acrylate or epoxy type by Grace, Rhodia, Evonik, PPG and Nanoresins AG.

Mention may also be made of nanoprecipitated calcium carbonates, such as that described in international application WO 98/16471 from Kautar Oy, or metal oxides (titanium dioxide, zinc oxide, cerium oxide, silver oxide, iron oxide, magnesium oxide, aluminum oxide) rendered nanometric, for example by combustion (products sold by Evonik under the Aeroxide or Aerodisp names) or by acid attack (products sold by Sasol under the Disperal or Dispal names).

Mention may also be made of proteins precipitated or coagulated in the form of nanometric beads. Finally, mention may be made of polysaccharides, such as starches, placed in the nanospherical form, such as the crosslinked starch nanoparticles with a size of between 50 and 150 nanometers sold under the Ecosphere name by Ecosynthetix, or starch acetate nanoparticles Cohpol C6N100 from VTT, or nanobeads synthesized directly in the nanometric state, for example those of polystyrenemaleimides from Topchim.

The nanometric product (b) which can be used can finally be provided in the form of mixtures of the nanometric products listed above. Such nanometric products may have also been placed on supports, such as talcs, zeolites or amorphous silicas, introduced into a polymer matrix or suspended in water or organic solvents.

As such, the Applicant Company has found that the cationic oligomers which it has selected for the purpose of obtaining a virtually complete exfoliation of the lamellar clays as emphasized above can advantageously constitute excellent dispersing agents for nanofillers in general, in particular of nanobead, nanocrystal or nanotube type.

The thermoplastic or elastomeric composition according to the invention additionally comprises at least one polymer other than starch.

The nonamylaceous polymer can be of any chemical nature. It advantageously comprises functional groups having active hydrogen and/or functional groups which give, in particular by hydrolysis, such functional groups having active hydrogen.

It can be a polymer of natural origin or else a synthetic polymer obtained from monomers of fossil origin and/or from monomers resulting from renewable natural resources.

The polymers of natural origin can in particular be obtained directly by extraction from plants or animal tissues. They are preferably modified or functionalized and in particular are chosen from polymers of protein, cellulose or lignocellulose nature, chitosans and natural rubbers. They can also be polymers obtained by extraction from microorganism cells, such as polyhydroxyalkanoates (PHAs).

Such a polymer of natural origin can be chosen from flours or proteins which have or have not been modified; unmodified or modified celluloses, in particular modified by carboxymethylation, ethoxylation, hydroxypropylation, cationization, acetylation or alkylation; hemicelluloses, lignins; modified or unmodified guar gums; chitins and chitosans; natural gums and resins, such as natural rubbers, rosins, shellacs and terpene resins; polysaccharides extracted from algae, such as alginates and carrageenans; polysaccharides of bacterial origin, such as xanthans or PHAs; or lignocellulose fibers, such as fibers of flax, hemp, bamboo, sisal, miscanthus or others.

The nonamylaceous polymer, preferably carrying functional groups having active hydrogen and/or functionalized, can be synthetic and can be chosen from synthetic polymers, in particular of the following types: polyester, polyacrylic, polyacetal, polycarbonate, polyamide, polyimide, polyurethane, polyolefin (in particular polyethylene, polypropylene, polyisobutylene and their copolymers), functionalized polyolefin, styrene, functionalized styrene, vinyl, functionalized vinyl, functionalized fluorinated, functionalized polysulfone, functionalized polyphenyl ether, functionalized polyphenyl sulfide, functionalized silicone, functionalized polyether and any blend of the abovementioned polymers.

Mention may be made, by way of example, of PLAs, PHAs, PBSs, PBSAs, PBATs, PETs, polyamides, such as polyamides 6, 6,6, 6,10, 6,12, 11 and 12, copolyamides, polyacrylates, poly(vinyl alcohol), poly(vinyl acetate), ethylene/vinyl acetate (EVA) copolymers, ethylene/methylacrylate (EMA) copolymers, ethylene/vinyl alcohol (EVOH) copolymers, polyoxy-methylenes (POMs), acrylonitrile/styrene/acrylate (ASA) copolymers, thermoplastic polyurethanes (TPUs), functionalized polyethylenes or polypropylenes, for example functionalized by silane, acrylic or maleic anhydride units, and functionalized styrene/butylene/-styrene (SBS) and styrene/ethylene/butylene/styrene (SEBS) copolymers, for example functionalized by maleic anhydride units, and any blend of these polymers.

Preferably, the nonamylaceous polymer is a polymer synthesized from bio-sourced monomers, that is to say monomers resulting from natural resources renewable before long, such as plants, microorganisms or gases, in particular from sugars, glycerol, oils or their derivatives, such as mono-, di- or polyfunctional alcohols or acids. It can in particular be synthesized from bio-sourced monomers, such as bio-ethanol, bio-ethylene glycol, bio-propanediol, bio-sourced 1,3-propanediol, bio-butanediol, lactic acid, bio-sourced succinic acid, glycerol, isosorbide, sorbitol, sucrose, diols derived from vegetable or animal oils and pine-extracted resin acids, and also their derivatives, it being understood that said bio-sourced monomers advantageously comprise at least 15%, preferably at least 30%, in particular at least 50%, better still at least 70%, indeed even more than 80%, of carbon of renewable origin within the meaning of standard ASTM D 6852 and/or standard ASTM D 6866, with respect to the combined carbon present in said monomers.

The nonamylaceous polymer can be polyethylene resulting from bio-ethanol, PVC resulting from bio-ethanol, polypropylene resulting from bio-propanediol, polyesters of PLA or PBS type based on bio-sourced lactic acid or on bio-sourced succinic acid, polyesters of PBAT type based on bio-sourced butanediol or on bio-sourced succinic acid, polyesters of Sorona® type based on bio-sourced 1,3-propanediol, polycarbonates comprising isosorbide, polyethylene glycols based on bio-ethylene glycol, polyamides based on castor oil or on plant polyols, and polyurethanes based, for example, on plant diols or plant polyols, such as glycerol, isosorbide, sorbitol or sucrose, and/or based on fatty acids which are optionally hydroxyalkylated.

Preferably, the nonamylaceous polymer is chosen from ethylene/vinyl acetate (EVA) copolymers, polyethylenes (PEs) and polypropylenes (PPs) which are nonfunctionalized or functionalized by silane units, acrylic units or maleic anhydride units, thermoplastic polyurethanes (TPUs), PBSs, PBSAs and PBATs, styrene/butylene/styrene (SBS) copolymers which are preferably functionalized, in particular by maleic anhydride units, amorphous poly(ethylene terephthalate)s (PETGs), synthetic polymers obtained from bio-sourced monomers, polymers extracted from plants, from animal tissues and from microorganisms which are optionally functionalized, and the blends of these.

Advantageously, the nonamylaceous polymer exhibits a weight-average molecular weight of between 8500 and 10 000 000 daltons, in particular of between 15 000 and 1 000 000 daltons.

Furthermore, the nonamylaceous polymer is preferably composed of carbon of renewable origin within the meaning of standard ASTM D 6852 and is advantageously nonbiodegradable or noncompostable within the meaning of standards EN 13432, ASTM D 6400 and ASTM D 6868.

According to a preferred alternative form, the nonamylaceous polymer (c) is a polymer comprising at least 15%, preferably at least 30%, in particular at least 50%, better still at least 70%, indeed even more than 80%, of carbon of renewable origin within the meaning of standard ASTM D 6852 and/or standard ASTM D 6866, with respect to the combined carbon present in said polymer.

According to another preferred alternative form, the nonamylaceous polymer is a nonbiodegradable polymer.

Among all the abovementioned categories and natures of polymers, the nonbiodegradable nonamylaceous polymer can be chosen in particular from ethylene/vinyl acetate (EVA) copolymers, polyethylenes (PEs) and polypropylenes (PPs), polyethylenes (PEs) and polypropylenes (PPs) functionalized by silane, acrylic or maleic anhydride units, thermoplastic polyurethanes (TPUs), styrene/ethylene/butylene/styrene (SEBS) block copolymers functionalized by maleic anhydride units, synthetic polymers obtained from bio-sourced monomers and polymers extracted from natural resources (secretions or extracts of plants, of animal tissues and of microorganisms), which are modified or functionalized, and their blends.

Mention may be made, as particularly preferred examples of nonbiodegradable nonamylaceous polymers which can be used in the present invention, of polyethylenes (PEs) and polypropylenes (PPs), which are preferably functionalized, thermoplastic polyurethanes (TPUs), polyamides, styrene/ethylene-butylene/styrene (SEBS) triblock block copolymers and amorphous polyethylene terephthalate)s (PETGs).

The amylaceous composition (a), the nanometric product (b) and the nonamylaceous polymer (c) can together represent 100% by weight (dry/dry) of thermoplastic or elastomeric composition according to the invention.

Fillers and other additives of any nature, including those described in detail below, can however be incorporated in the thermoplastic or elastomeric composition of the present invention. Although the proportion of these additional ingredients can be quite high, the amylaceous composition (a), which is preferably plasticized, the nanometric product (b) and the nonamylaceous polymer (c), which is preferably nonbiodegradable, together represent preferably at least 30% by weight (dry/dry), in particular at least 40% by weight (dry/dry) and ideally at least 50% by weight (dry/dry) of thermoplastic or elastomeric composition of the present invention.

Among the additives, it is possible in particular to add, to said composition, at least one coupling agent.

The term “coupling agent” is understood to mean, in the present invention, any organic molecule carrying at least two free or masked functional groups capable of reacting with molecules carrying functional groups having active hydrogen, such as the starch or the plasticizer of the starch. This coupling agent can be added to the composition in order to make possible the attaching, via covalent bonds, of at least a portion of the plasticizer to the starch and/or to the nonamylaceous polymer optionally added.

This coupling agent can then be chosen, for example, from compounds carrying at least two identical or different and free or masked functional groups chosen from isocyanate, carbamoylcaprolactam, aldehyde, epoxide, halo, protonic acid, acid anhydride, acyl halide, oxychloride, trimetaphosphate or alkoxysilane functional groups and combinations of these.

It can advantageously be chosen from the following compounds:
diisocyanates and polyisocyanates, preferably 4,4′-dicyclohexylmethane diisocyanate (H12MDI), methylenediphenyl diisocyanate (MDI), toluene diisocyanate (TDI), naphthalene diisocyanate (NDI), hexamethylene diisocyanate (HMDI) and lysine diiso-cyanate (LDI),
dicarbamoylcaprolactams, preferably 1,1′-carbonylbis-caprolactam,
glyoxal, dialdehyde starches and TEMPO-oxidized starches,
diepoxides,
halohydrins, that is to say compounds comprising an epoxide functional group and a halogen functional group, preferably epichlorohydrin,
organic diacids, preferably succinic acid, adipic acid, glutaric acid, oxalic acid, malonic acid or maleic acid, and the corresponding anhydrides,
oxychlorides, preferably phosphorus oxychloride,
trimetaphosphates, preferably sodium trimeta-phosphate,
alkoxysilanes, preferably tetraethoxysilane, and
any mixture of these compounds.

In a preferred embodiment of the invention, the coupling agent is a diisocyanate, in particular methylenediphenyl diisocyanate (MDI) or 4,4′-dicyclohexylmethane diisocyanate (H12MDI).

The amount of coupling agent, expressed by dry weight and with respect to the sum, also expressed by dry weight, of the amylaceous composition (a) and of the nanometric product (b), is advantageously between 0.1 and 15% by weight, preferably between 0.1 and 12% by weight, more preferably still between 0.2 and 9% by weight and in particular between 0.5 and 5% by weight.

The optional but preferred incorporation of the coupling agent in the mixture of the amylaceous composition (a) and of the nanometric product (b) can be carried out by physical mixing under cold conditions or at low temperature but preferably by kneading under hot conditions at a temperature greater than the glass transition temperature of the amylaceous composition. This kneading temperature is advantageously between 60 and 200° C. and better still from 100 to 160° C. This incorporation can be carried out by thermomechanical mixing, batchwise or continuously and in particular in line. In this case, the mixing time can be short, from a few seconds to a few minutes.

The composition according to the invention can additionally comprise various other additives. They can be products targeted at yet further improving its physicochemical properties, in particular its physical structure, its processing behavior and its durability, or else its mechanical, thermal, conductive, adhesive or organoleptic properties.

The additive can be an agent which improves or adjusts the mechanical or thermal properties chosen from inorganic materials, salts and organic substances. It can relate to nucleating agents, such as talc, to compatibilizing or dispersing agents, such as natural or synthetic surface-active agents, to agents which improve the impact strength or scratch resistance, such as calcium silicate, to agents which regulate shrinkage, such as magnesium silicate, to agents which trap or deactivate water, acids, catalysts, metals, oxygen, infrared radiation or UV radiation, to hydrophobizing agents, such as oils and fats, to flame-retardant and fireproofing agents, such as halogenated derivatives, to antismoke agents or to inorganic or organic reinforcing fillers, such as calcium carbonate, talc, plant fibers, glass fibers or kevlar.

The additive can also be an agent which improves or adjusts the conductive or insulating properties with regard to electricity or heat or the leaktightness, for example toward air, water, gases, solvents, fatty substances, gasolines, aromas or fragrances, chosen in particular from inorganic materials, salts and organic substances, in particular from agents which conduct or dissipate heat, such as metal powders and graphites.

The additive can also be an agent which improves the organoleptic properties, in particular:
scented properties (fragrances or odor-masking agents),
optical properties (gloss agents, whiteness agents, such as titanium dioxide, dyes, pigments, dye enhancers, opacifiers, mattness agents, such as calcium carbonate, thermochromic agents, phosphorescence and fluorescence agents, metalizing or marbling agents and antimist agents),
sound properties (barium sulfate and barites), and
tactile properties (fatty substances).

The additive can also be an agent which improves or adjusts the adhesive properties, in particular the properties of adhesion with regard to cellulose materials, such as paper or wood, metal materials, such as aluminum and steel, materials made of glass or ceramic, textile materials and inorganic materials, such as, in particular, pine resins, rosins, ethylene/vinyl alcohol copolymers, fatty amines, lubricating agents, mold-release agents, antistatic agents and antiblocking agents.

Finally, the additive can be an agent which improves the durability of the material or an agent for controlling its (bio)degradability, chosen in particular from hydrophobizing or beading agents, such as oils and fats, corrosion inhibitors, antimicrobial agents, such as Ag, Cu and Zn, decomposition catalysts, such as oxo catalysts, and enzymes, such as amylases.

Use may be made, for the purpose of the preparation of the thermoplastic or elastomeric composition according to the invention, of numerous processes providing in particular extremely varied moments and orders of introduction of the components of said composition (starch, optional plasticizer of the starch, nanometric product (b), nonamylaceous polymer (c), optional additives).

Thus, the nanometric product can be introduced after having, in all or part, been dispersed beforehand in the amylaceous composition, preferably plasticized, and/or in the nonamylaceous polymer (c) or been introduced in last place after introduction of the amylaceous composition and of the nonamylaceous polymer. In addition, in the final composition, said nanometric product, whatever the way in which and the moment at which it was incorporated, can be encountered dispersed mainly either in the amylaceous phase or in the nonamylaceous polymeric phase or can be encountered located at the interfaces of these two phases.

Among all these possibilities for processing said components, a subject matter of the present invention is in particular a process for the preparation of a thermoplastic or elastomeric composition as described above in all its alternative forms, said process comprising the following stages:
(i) selection of at least one starch and of at least one plasticizer of this starch,
(ii) selection of at least one nanometric product (b) composed of particles having at least one dimension of between 0.1 and 500 nanometers, said nanometric product being chosen from:
   products formed of mixtures based on at least one lamellar clay and on at least one cationic oligomer,
   organic, inorganic or mixed nanotubes,
   organic, inorganic or mixed nanocrystals and nanocrystallites,
   organic, inorganic or mixed nanobeads and nanospheres,
   and the mixtures of these nanometric products,
(iii) preparation, preferably by thermomechanical mixing, of a composition with a starch crystallinity of less than 15%, preferably of less than 5% and more preferably of less than 1%, comprising the starch selected and its plasticizer,
(iv) incorporation in said composition of the nanometric product (b) selected and achievement of an intermediate composition based on at least one starch, one plasticizer of the latter and one nanometric product (b) (hereinafter “intermediate nanofilled amylaceous composition”),
   it being possible for stage (iv) to be carried out before, during or after stage (iii),
(v) selection of at least one nonamylaceous polymer (c), and
(vi) preparation of the thermoplastic or elastomeric composition according to the invention by incorporation of the nonamylaceous polymer (c) in the intermediate nanofilled amylaceous composition.

The intermediate nanofilled amylaceous compositions thus obtained during this process comprise various ingredients, namely the starch, the plasticizer and the nanometric product (b), intimately mixed with one another.

The incorporation of a plasticizer of the starch during stage (iii) can be carried out under cold conditions prior to the thermomechanical mixing thereof with the starch or else directly during this mixing, that is to say under hot conditions at a temperature preferably of between 60 and 200° C., more preferably between 80 and 185° C. and in particular of between 100 and 160° C., batchwise, for example by masticating/kneading, or continuously, for example by extrusion. The duration of this mixing can range from a few seconds to a few hours, according to the mixing method selected.

Furthermore, the incorporation of the nanometric product (b) (stage (iv)) can be carried out by physical mixing under cold conditions or at low temperature with the amylaceous composition but preferably by kneading under hot conditions at a temperature greater than the glass transition temperature of the amylaceous composition. This kneading temperature is advantageously between 60 and 200° C., preferably between 80 and 180° C. and more preferably between 100 and 160° C. This incorporation can be carried out by thermomechanical mixing, batchwise or continuously and in particular in line. In this case, the mixing time can be short, from a few seconds to a few minutes. A thermoplastic composition is thus obtained which is very homogeneous, as can be observed by observation under a microscope.

In one embodiment of the process according to the invention, the nanometric product (b) is composed of a product of mixing based on at least one lamellar clay and on at least one cationic oligomer and the exfoliation of the clay takes place during stage (iii) of mixing the starch and the plasticizer.

The incorporation of the nonamylaceous polymer (c) in the intermediate nanofilled amylaceous composition during stage (vi) can be carried out by kneading under hot conditions, preferably at a temperature of between 60 and 200° C., more preferably of between 100 and 200° C. and in particular of between 120 and 185° C. This incorporation can be carried out by thermomechanical mixing, batchwise or continuously and in particular in line. In this case, the mixing time can be short, from a few seconds to a few minutes.

According to an advantageous alternative form, this process is characterized in that:
stage (iv) is carried out by kneading under hot conditions at a temperature of between 80 and 180° C., and
stage (vi) is carried out by kneading under hot conditions at a temperature of between 120 and 185° C.

In the context of its research studies, the Applicant Company has found that, contrary to all expectations, very small amounts of nanometric product (b) make it possible to considerably reduce the sensitivity to water and to water vapor of the intermediate nanofilled amylaceous composition but also of the final thermoplastic or elastomeric composition obtained, in comparison with the products prepared without addition of nanometric product. This opens the route to novel applications of the intermediate nanofilled amylaceous compositions but also for thermoplastic and/or elastomeric compositions of the invention.

The Applicant Company has also found that said nanofilled amylaceous composition exhibits a lower sensitivity to thermal decomposition and a lesser coloring than the plasticized starches of the prior art.

Furthermore, said composition exhibits a complex viscosity, measured on a rheometer of Physica MCR 501 or equivalent type, of between 10 and 10⁶ Pa·s, for a temperature of between 100 and 200° C. This viscosity is significantly lower than that measured for an identical composition not comprising a few percent of nanometric product (b), such as a pyrogenic hydrophilic silica of Aerosil 200 type, for example.

For the purpose of the processing thereof by injection molding, for example, its viscosity at these temperatures is preferably situated in the lower part of the range given above and the composition is then preferably a hot-melt composition within the meaning specified above.

The intermediate nanofilled amylaceous composition additionally exhibits the advantage of being composed of essentially renewable starting materials and of being able to exhibit, after adjustment of the formulation, the following properties of use in multiple applications in plastics technology or in other fields:
appropriate thermoplasticity, appropriate melt viscosity and appropriate glass transition temperature, within the usual ranges of values known for current polymers (Tg from −50° to 150° C.), making processing possible by virtue of the existing industrial plants conventionally used for normal synthetic polymers,
sufficient miscibility with a great variety of polymers of fossil origin or of renewable origin on the market or in development,
satisfactory physicochemical stability toward the processing conditions,
low sensitivity to water and to water vapor,
mechanical performance which is very markedly improved in comparison with the starch thermoplastic compositions of the prior art (flexibility, elongation at break, maximum tensile strength),
good barrier effects to water, water vapor, oxygen, carbon dioxide, UV radiation, fatty substances, aromas, gasolines and fuels,
opacity, translucency or transparency which can be adjusted according to the uses,
good printability and ability to be painted, in particular by inks and paints in aqueous phase,
controllable dimensional shrinkage,
highly satisfactory stability over time,
and adjustable biodegradability, compostability and/or recyclability.

The abovementioned advantages of any intermediate nanofilled amylaceous composition can be, in all or part, taken advantage of in any thermoplastic or elastomeric composition according to the invention.

Furthermore, another subject matter of the present invention is the use of a composition comprising at least one starch, preferably at least one plasticizer of said starch and at least one nanometric product (b) as defined above in the preparation of a thermoplastic or elastomeric composition according to the invention or obtained by the process according to the invention.

The present invention also relates to the use of at least one nonamylaceous polymer (c), for example a nonbiodegradable polymer, in the preparation of a thermoplastic or elastomeric composition according to the invention or obtained by the process according to the invention.

The composition according to the invention, for example existing in the form of a mixture between said intermediate composition and a nonamylaceous polymer, can advantageously exhibit stress/strain curves characteristic of a ductile material and not of a material of brittle type. The elongation at break is greater than 40%, preferably greater than 80%, better still greater than 90%. This elongation at break can advantageously be at least equal to 95%, in particular at least equal to 120%. It can even reach or exceed 180%, indeed even 250%. It is in general reasonably less than 500%.

The maximum tensile strength of the compositions of the present invention is generally greater than 4 MPa, preferably greater than 6 MPa, better still greater than 8 MPa. It can even reach or exceed 10 MPa, indeed even 20 MPa. It is in general reasonably less than 80 MPa.

The thermoplastic or elastomeric composition according to the invention can also exhibit the advantage of being virtually or completely insoluble in water, of hydrating with difficulty and of retaining good physical integrity after immersion in water. Its level of insoluble materials after 24 hours in water at 20° C. is preferably greater than 90%. Very advantageously, it can be greater than 92%, in particular greater than 95%. Ideally, this level of insoluble materials can be at least equal to 98% and in particular be approximately 100%.

In an entirely noteworthy way, the composition according to the present invention can in particular simultaneously exhibit:
a level of insoluble materials at least equal to 98%,
an elongation at break at least equal to 95%, and
a maximum tensile strength of greater than 8 MPa.

The thermoplastic or elastomeric composition according to the invention can be used as is or as a blend with other products or additives, including other synthetic or artificial polymers or polymers of natural origin. It can be biodegradable or compostable within the meaning of standards EN 13432, ASTM D 6400 and ASTM D 6868 and can then comprise polymers or materials corresponding to these standards, such as PLA, PCL, PBS, PBSA, PBAT and PHA.

It can in particular make it possible to correct some major known failings of PLA (polylactic acid), namely:
the mediocre barrier effect to CO₂ and to oxygen,
the inadequate barrier effects to water and to water vapor,
the resistance to heat which is inadequate for the manufacture of bottles and the resistance to heat which is highly inadequate for use as textile fibers, and
a brittleness and a lack of flexibility in the form of films.

However, the composition according to the invention can also be nonbiodegradable or noncompostable within the meaning of the above standards and can then comprise, for example, highly functionalized, crosslinked or etherified extracted polymers or starches or known synthetic polymers. It is possible to adjust the lifetime and the stability of the composition in accordance with the invention by adjusting in particular its affinity for water, so as to be suitable for the expected uses as material and for the methods of recovering in value envisaged at the end of life.

The composition according to the invention can in particular comprise a nonbiodegradable polymer chosen from the group consisting of polyethylenes (PEs) and polypropylenes (PPs), which are preferably functionalized, thermoplastic polyurethanes (TPUs), polyamides, styrene/ethylene-butylene/styrene (SEBS) triblock block copolymers and amorphous polyethylene terephthalate)s (PETGs).

The thermoplastic and/or elastomeric composition in accordance with the present invention advantageously comprises at least 15%, preferably at least 30%, in particular at least 50%, better still at least 70%, indeed even more than 80%, of carbon of renewable origin within the meaning of standard ASTM D 6852 and/or of standard ASTM D 6866, with respect to the combined carbon present in the composition. This carbon of renewable origin is essentially that constituting the starch necessarily present in the composition in accordance with the invention but can also advantageously be, by a judicious choice of the constituents of the composition, that present in the optional plasticizer of the starch, as in the case, for example, of glycerol or sorbitol, but also that of the nonamylaceous polymer (c) or of any other constituent of the thermoplastic composition, when they originate from renewable natural resources, such as those defined preferentially above.

It can in particular be envisaged to use the compositions according to the invention as barrier films to oxygen, to carbon dioxide gas, to aromas, to fuels and/or to fatty substances, alone or in multilayer structures obtained by coextrusion for the field of food packaging in particular.

They can also be used to increase the hydrophilic nature, the fitness for electrical conduction, the permeability to water and/or to water vapor or the resistance to organic solvents and/or fuels of synthetic polymers in the context, for example, of the manufacture of printable electronic labels, films or membranes, of textile fibers or of containers or tanks, or of improving the adhesive properties of synthetic hot-melt films on hydrophilic supports.

It should be noted that the hydrophilic nature of the thermoplastic or elastomeric composition according to the invention considerably reduces the risks of bioaccumulation in the adipose tissues of living organisms and thus also in the food chain.

Said composition can be provided in the pulverulent, granulated or bead form. It can constitute as is a masterbatch or the matrix of a masterbatch intended to be diluted in a bio-sourced or non-biosourced matrix.

It can also constitute a plastic starting material or a compound which can be used directly by a components manufacturer or a custom molder of plastic objects.

It can also constitute as is an adhesive or a matrix for formulation of an adhesive, in particular of hot-melt type or a hot-melt adhesive.

It can constitute a base gum or the matrix of a base gum, in particular for chewing gum, or also a resin or co-resin for rubbers and elastomers.

Finally, the composition according to the invention can optionally be used to prepare thermoset resins (duroplasts) by irreversibly exhaustive crosslinking, said resins thus definitively losing all thermoplastic or elastomeric nature.

The invention also relates to a plastic, an elastomeric material or an adhesive material comprising the composition of the present invention or a finished or semifinished product obtained from the latter.

### EXAMPLE 1

### Amylaceous Composition According to the Prior Art and Nanofilled Amylaceous Compositions which can be Used According to the invention obtained with wheat starch, a Starch Plasticizer and a Nanometric Product

### Preparation of the Compositions

The choice is made, for this example:
as granular starch, of a native wheat starch sold by the Applicant Company under the name “Wheat starch SP” exhibiting a water content of approximately 12%,
as plasticizer of the granular starch, of a concentrated aqueous composition of polyols (sorbitol, glycerol) sold by the Applicant Company under the name Polysorb® G84/41/00 having a water content of approximately 16%,
as nanometric products (b), of respectively:
pyrogenic silica (approximately 15 nm) sold under the name Aerosil 200 by Evonik,
hydrophobic silica (approximately 25 nm) sold under the name Aerosil R 974 by the same company,
the product LAB 4019, nanometric particles (approximately 40 nm) of polystyrenemaleimide,
the product LAB 4020, nanometric particles (approximately 70 nm) of calcium carbonate,
the product LAB 4021, nanometric particles (approximately 200 nm) of starch acetate.

First, for purposes of comparison, a thermoplastic amylaceous composition according to the prior art is prepared. For this, a twin-screw extruder from TSA, with a diameter (D) of 26 mm and a length of 50D, is fed with the starch and the plasticizer, at a speed of 150 rev/min, with a mixing ratio of 67 parts of Polysorb® plasticizer per 100 parts of wheat starch.

The extrusion conditions are as follows:
Temperature profile (ten heating zones Z1 to Z10): 90/90/110/130/140/150/140/130/120/120, without venting.

At the extruder outlet, the plasticized starch rods are cooled in the air on a conveyor belt in order to be subsequently dried at 80° C. in an oven under vacuum for 10 hours before being ground.

The amylaceous composition thus obtained according to the prior art is called, after drying, “Composition AP6040”.

Various nanofilled amylaceous compositions which can be used according to the invention are prepared in an identical fashion by dry blending, with the wheat starch, amounts, with respect to the starch by dry weight, of 6.9% (i.e., approximately 4%, by weight (dry/dry), of nanometric product (b) expressed with regard to the total plasticized amylaceous composition (a)+nanometric product (b)) of one or other of the 5 nanometric products (b) defined above.

TABLE 1
Melt flow index (MFI) and degree of water
uptake after drying a thermoplastic composition
according to the prior art and nanofilled amylaceous
compositions according to the invention

| | | Degree of |
|---|---|---|
| | MFI | water uptake |
| Tests | (130° C./20 kg) | after drying |
| AP6040 without | No flow- | 5.8 |
| nanometric product | too viscous | |
| AP6040 with LAB 4019 | 7.1 | 4.0 |
| AP6040 with LAB 4020 | 7.2 | 3.5 |
| AP6040 with LAB 4021 | 2.8 | 3.7 |
| AP6040 with Aerosil R974 | 0.7 | 3.8 |
| AP6040 with Aerosil 200 | 2.8 | 3.7 |

The addition of one or other of the nanometric products (b) has a very marked beneficial effect on the melt flow index (MFI) of the amylaceous compositions which, after addition of the nanometric products (b), become very fluid and flow without difficulty at 130° C. under a load of 20 kg, in contrast to the composition of the prior art devoid of nanometric product.

The water uptake after 30 days in ambient atmosphere also appears markedly improved by the presence of the nanometric products (b).

Starting from these bases AP6040, blends comprising 50% in total, by weight, of commercial polypropylene and of polypropylene grafted with maleic anhydride were prepared.

The extrusion conditions are given below.
Dry blending the polypropylenes and the bases AP6040 in the main hopper
Screw speed, 400 rev/min
Temperature profile (° C.): 200/200/200/180/180/180/180/180/180/180
   Test for Measuring the Degree of Insoluble Materials after Immersion for 24 Hours

The sensitivity to water of the compositions prepared is evaluated.

The level of materials insoluble in water of the compositions obtained is determined according to the following protocol:

(i) the sample to be characterized is dried (12 hours at 80° C. under vacuum)
(ii) the weight of the sample (=Wg1) is measured with a precision balance
(iii) the sample is immersed in water at 20° C. (volume of water in ml equal to 100 times the weight in g of sample)
(iv) the sample is withdrawn after a defined time of several hours
(v) the excess water at the surface is removed with an absorbent paper as quickly as possible
(vi) the sample is placed on a precision balance and the loss in weight is monitored for 2 minutes (measurement of the weight every 20 seconds)
(vii) the sample is dried (for 24 hours at 80° C. under vacuum)
(viii) the weight of the dry sample (=Wg2) is measured
(ix) the level of insoluble materials, expressed as percent, is calculated according to the formula Wg2/Wg1.

TABLE 2
Results on the blends

| | Level of insoluble | |
|---|---|---|
| | materials after | Moisture |
| | immersion for 24 h | level |
| Type of blend | (%) | (%) |
| AP6040 without nanometric | 94.5 | 2.1 |
| product/PP | | |
| AP6040 with LAB 4020/PP | 99.1 | 1.6 |
| AP6040 with LAB 4021/PP | 96.9 | 1.7 |
| AP6040 with Aerosil R974/PP | 100.0 | 1.4 |
| AP6040 with Aerosil 200/PP | 100.0 | 1.2 |

It is observed that the presence of nanometric products (b) in the bases AP6040 has a very marked effect in terms of reducing the sensitivity to water during immersion of the blends and of reducing the sensitivity to water uptake of the alloys dried at 80° C. for 10 hours.

### EXAMPLE 2

### Effect of the Amount of Nanometric Product (Aerosil 200)

New compositions are prepared as in example 1 while varying the amount of nanometric product (b) Aerosil 200. Three tests are carried out using the following amounts, with respect to the amount of dry starch: 0.1%, 1.2% and 6.9%, i.e., respectively, 0.06%, 0.75% and 4% approximately of nanometric product (b) expressed by weight (dry/dry) with respect to the total of plasticized amylaceous composition (a)+nanometric product (b).

The results are as follows:

TABLE 3
MFI and degree of water uptake

| | | Degree of |
|---|---|---|
| | MFI | water uptake |
| Tests | (130° C./20 kg) | after drying |
| AP6040 without | No flow- | 5.8 |
| nanometric product | too viscous | |
| AP6040 with 0.1% | Very slight flow | 5.7 |
| of Aerosil 200 | not quantifiable | |
| | by MFI | |
| AP6040 with 1.2% | 0.1 | 5.0 |
| of Aerosil 200 | | |
| AP6040 with 6.9% | 2.8 | 3.7 |
| of Aerosil 200 | | |

It may be observed that the addition of Aerosil 200 has beneficial effects even at 0.1% of addition with respect to the dry starch, i.e. 0.06% approximately (dry/dry) with respect to the total AP6040 (amylaceous composition (a))+Aerosil (nanometric product (b)).

### EXAMPLE 3

### Effect on Blends with Glucidex® 6

First, for the purposes of comparison, a thermoplastic composition based on a maltodextrin sold by the Applicant Company under the trade name Glucidex® 6 plasticized with the concentrated aqueous composition of polyols Polysorb® G 84/41/00 used in example 1 and on a thermoplastic polyurethane (TPU) sold under the Estane 58277 brand is prepared.

For this, a twin-screw extruder from TSA, with a diameter (D) of 26 mm and a length of 50D, is fed with the maltodextrin and the plasticizer, at a speed of 200 rev/min, with a mixing ratio of 67 parts of Polysorb® plasticizer per 100 parts of maltodextrin.

The extrusion conditions are as follows:
Temperature profile (ten heating zones Z1 to Z10): 90/90/110/140/140/110/90/90/90/90

At the extruder outlet, the maltodextrin rods are cooled in the air on a conveyor belt in order to be subsequently dried at 80° C. in an oven under vacuum for 12 hours before being ground.

The composition thus obtained is called, after drying, “Composition 1”.

A nanofilled amylaceous composition which can be used according to the invention is subsequently prepared in an identical fashion by dry blending, with the maltodextrin, an amount with respect to the maltodextrin by dry weight of 8.6% of nanometric product (b) Aerosil 200, i.e. a weight (dry/dry) of approximately 5.2%, expressed as nanometric product (b) with regard to the total plasticized amylaceous composition (a)+nanometric product (b).

The nanofilled amylaceous composition thus obtained is called, after drying, “Composition 2”.

Finally, starting from these compositions 1 and 2, blends comprising, by weight, 50% of these compositions and 50% of Estane 58277 TPU (thermoplastic polyurethane) are prepared.

An additional test is carried out with addition, to composition 2, of 4 parts of methylenediphenyl diisocyanate (MDI) per 100 parts of composition 2.

The extrusion conditions (twin-screw extruder, Ø26, 50D) are given below:
Dry blending (dried TPU, amylaceous base) in the main hopper
Screw speed, 300 rev/min
Temperature profile (° C.): 130/180/180/150/150/150/130/130/130/130

### Measurement of the Mechanical Properties

The tensile mechanical characteristics of the various samples are determined according to standard NF T51-034 (Determination of the tensile properties) by using a Lloyd Instruments LR5K test bench, a tensioning rate of 300 mm/min and standardized test specimens of H2 type.

The elongation at break and the corresponding maximum tensile strength are noted, for each of the alloys, from the stress/strain curves (strength=f(elongation)) obtained at a drawing rate of 50 mm/min.

TABLE 4
Mechanical characteristics (strength and
elongation at break at 300 mm/min) of the alloys

| | Tensile | Elongation |
|---|---|---|
| | strength | at break |
| Tests | (MPa) | (%) |
| Composition 1/TPU | 10 | 30 |
| Composition 2/TPU | 26 | 700 |
| (according to | | |
| the invention) | | |
| Composition 2/TPU/MDI | 26 | 615 |
| (according to | | |
| the invention) | | |

The mechanical properties without addition of nanometric product (b) are poor whereas, with introduction of 8.3% of Aerosil 200, the mechanical characteristics approach those of a pure TPU.

The additional incorporation of MDI in the alloy also makes it possible to obtain excellent mechanical properties but in addition, as the Applicant Company has furthermore been able to find, to improve the level of insoluble materials and the resistance to water and to moisture.

Other tests have also been carried out by the Applicant Company with, in the alloy Composition 2/TPU, the TPU being completely replaced by various nonamylaceous polymers, with the selection of a PLA, a PHA, a PBAT, a polyamide, an ethylene/vinyl acetate (EVA) copolymer, an ethylene/vinyl alcohol (EVOH) copolymer, a polyoxy-methylene (POM), an acrylonitrile/styrene/acrylate (ASA) copolymer, a polyolefin functionalized by a maleic anhydride unit, a styrene/butylene/styrene (SBS) copolymer or a styrene/ethylene/butylene/styrene (SEBS) copolymer.

Improvements in properties were recorded in comparison with the same alloys devoid of nanometric product (b) Aerosil 200.

1-25. (canceled)

26. A thermoplastic or elastomeric composition comprising:
at least 50% by weight and at most 99.95% by weight of an amylaceous composition (a) comprising at least one starch,
at least 0.05% by weight and at most 50% by weight of a nanometric product (b) consisting of particles having at least one dimension of between 0.1 and 500 nanometers and selected from the group consisting of:
products formed of mixtures based on at least one lamellar clay and on at least one cationic oligomer,
organic, inorganic or mixed nanotubes,
organic, inorganic or mixed nanocrystals and nanocrystallites,
organic, inorganic or mixed nanobeads and nanospheres which are separate, in bunches or agglomerated, and
any mixture of at least two of these nanometric products, these percentages being expressed by dry weight and with respect to the sum, by dry weight, of (a) and (b), and
at least one nonamylaceous polymer (c).

27. The composition as claimed in claim 26, wherein the amylaceous composition (a) additionally comprises at least one plasticizer of the starch selected from the group consisting of diols, triols, polyols, hydrogenated glucose syrups, salts of organic acids, urea, methyl, ethyl or fatty esters of organic acids, acetic or fatty esters of monoalcohols, diols, triols or polyols, and any mixture of these products.

28. The composition as claimed in claim 27 the plasticizer is present in the amylaceous composition (a) in a proportion of 25 to 110 parts by dry weight per 100 parts by dry weight of starch.

29. The composition as claimed in claim 26, wherein the starch used in the preparation of the amylaceous composition (a) is selected from the group consisting of granular starches, water-soluble starches and organomodified starches.

30. The composition as claimed in claim 29, wherein the starch used in the preparation of the amylaceous composition (a) is a granular starch selected from the group consisting of fluidized starches, oxidized starches, starches which have been subjected to a chemical modification, white dextrins and the mixtures of these products.

31. The composition as claimed in claim 29, wherein the starch used in the preparation of the amylaceous composition (a) is a water-soluble starch selected from the group consisting of pregelatinized starches, extruded starches, atomized starches, highly converted dextrins, maltodextrins, functionalized starches and the mixtures of these products.

32. The composition as claimed in claim 29, wherein the starch used in the preparation of the amylaceous composition (a) is an organomodified starch selected from the group consisting of starch acetates, dextrin acetates and maltodextrin acetates, fatty esters of starches, fatty esters of dextrins fatty esters of maltodextrins with fatty chains of 4 to 22 carbons, said acetates and fatty esters exhibiting a degree of substitution (DS) of between 0.5 and 3.0.

33. The composition as claimed in claim 26, comprising from 0.1 to 4% of a nanometric product (b).

34. The composition as claimed in claim 33, comprising from 5 to 40% by weight of a nanometric product (b).

35. A thermoplastic or elastomeric composition, comprising:
from 25 to 85% by weight of at least one starch,
from 8 to 40% by weight of at least one starch plasticizer, other than water,
from 2 to 40% by weight of a nanometric product (b) consisting of particles having at least one dimension of between 0.1 and 500 nanometers and selected from the group consisting of:
products formed of mixtures based on at least one lamellar clay and on at least one cationic oligomer,
organic, inorganic or mixed nanotubes,
organic, inorganic or mixed nanocrystals and nanocrystallites,
organic, inorganic or mixed nanobeads and nanospheres which are separate, in bunches or agglomerated,
and the mixtures of at least two of these nanometric products, and
from 5 to 60% by weight of at least one nonamylaceous polymer (c),
these percentages being expressed by dry weight and with respect to the total dry weight of the thermoplastic or elastomeric composition.

36. The composition as claimed in claim 26, wherein the nanometric product (b) consists of particles having at least one dimension of between 5 and 50 nanometers.

37. The composition as claimed in claim 26, wherein the starch present in the composition exhibits a degree of crystallinity of less than 15%.

38. The composition as claimed in claim 26, the nonamylaceous polymer (c) is selected from the group consisting of ethylene/vinyl acetate (EVA) copolymers, polyethylenes (PEs) and polypropylenes (PPs) which are nonfunctionalized or functionalized by silane units, acrylic units or maleic anhydride units, thermoplastic polyurethanes (TPUs), poly(butylene succinate)s (PBSs), poly(butylene succinate adipate)s (PBSAs) and poly(butylene adipate terephthalate)s (PBATs), styrene/butylene/styrene (SBS) copolymers which are preferably functionalized, in particular by maleic anhydride units, amorphous poly(ethylene terephthalate)s (PETGs), synthetic polymers obtained from bio-sourced monomers, polymers extracted from plants, from animal tissues and from microorganisms which are optionally functionalized, and the blends of these.

39. The composition as claimed in claim 38, wherein the nonamylaceous polymer (c) is a nonbiodegradable polymer selected from the group consisting of polyethylenes (PEs) and polypropylenes (PPs), functionalized polyethylenes and polypropylenes, thermoplastic polyurethanes (TPUs), polyamides, styrene/ethylene-butylene/styrene (SEBS) triblock block copolymers and amorphous poly(ethylene terephthalate)s (PETGs).

40. The composition as claimed in claim 26, further comprising a coupling agent selected from the group consisting of compounds carrying at least two identical or different and free or masked functional groups chosen from isocyanate, carbamoylcaprolactam, epoxide, aldehyde, halo, protonic acid, acid anhydride, acyl halide, oxychloride, trimetaphosphate or alkoxysilane functional groups and the mixtures thereof.

41. The composition as claimed in claim 26, said composition being nonbiodegradable or noncompostable within the meaning of standards EN 13432, ASTM D 6400 and ASTM D 6868.

42. The composition as claimed in claim 26, said composition comprising at least 15% of carbon of renewable origin (ASTM D 6852 and/or ASTM D 6866), expressed with respect to the combined carbon present in said composition.

43. The composition as claimed in claim 26, said composition exhibiting:
a level of insoluble materials at least equal to 98%,
an elongation at break at least equal to 95%, and
a maximum tensile strength of greater than 8 MPa.

44. A method for the preparation of a thermoplastic or elastomeric composition as claimed in claim 26, said method comprising the following stages:
(i) selection of at least one starch and of at least one plasticizer of this starch,
(ii) selection of at least one nanometric product (b) consisting of particles having at least one dimension of between 0.1 and 500 nanometers, said nanometric product being selected from the group consisting of:
products formed of mixtures based on at least one lamellar clay and on at least one cationic oligomer,
organic, inorganic or mixed nanotubes,
organic, inorganic or mixed nanocrystals and nanocrystallites,
organic, inorganic or mixed nanobeads and nanospheres,
and any mixture of these nanometric products,
(iii) thermomechanical mixing of the starch and of the plasticizer until a composition is obtained which exhibits a starch crystallinity of less than 15%,
(iv) incorporation into the composition obtained in stage
(iii) of the nanometric product (b) selected in stage (ii), so as to obtain an intermediate nanofilled amylaceous composition, stage (iv) being carried out before, during or after stage (iii),
(v) selection of at least one nonamylaceous polymer (c), and
(vi) incorporation of the nonamylaceous polymer (c) into the intermediate nanofilled amylaceous composition of stage (iv).

45. The process as claimed in claim 44, wherein the nanometric product (b) is a mixture of at least one lamellar clay and at least one cationic oligomer, and wherein stage (iii) is carried out so as to effect exfoliation of the clay.

46. The process as claimed in claim 44, wherein:
stage (iv) is carried out by kneading under hot conditions at a temperature of between 80 and 180° C., and
stage (vi) is carried out by kneading under hot conditions at a temperature of between 120 and 185° C.

47. The composition as claimed in claim 40, wherein the coupling agent is selected from the group consisting of:
diisocyanates,
dicarbamoylcaprolactams,
diepoxides,
compounds comprising an epoxide functional group and a halogen functional group,
organic diacids, and the corresponding anhydrides,
oxychlorides,
trimetaphosphates,
alkoxysilanes, and
mixtures of these compounds.
